(19) United States
(12) Patent Application Publication
(10) Pub. No.: US 2008/0263157 A1
(43) Pub. Date: Oct. 23, 2008

(54) METHOD AND SYSTEM FOR ORDERING INSTANT MESSAGES

(76) Inventors: Kulvir Singh Bhogal, Fort Worth, TX (US); Alexandre Polozoff, Bloomington, IL (US); Newton James Smith, Austin, TX (US)

Correspondence Address: IBM CORP (YA);C/O YEE & ASSOCIATES PC, P.O. BOX 802333, DALLAS, TX, 75380, US

(21) Appl. No.: 11/736,956

(22) Filed: Apr. 18, 2007

(51) Int. Cl. G06F 15/16

(52) U.S. Cl. 709/206

(57) ABSTRACT

A computer implemented method and a computer usable program product for ordering a plurality of instant messages are provided. A data processing system receives at least one incoming instant message. Responsive to identifying the at least one incoming instant message as a response to at least one outgoing instant message originating from the data processing system, the data processing system associates the at least one incoming instant message with the at least one outgoing instant message to form a set of related messages. The data processing system presents the at least one incoming instant message to a first user, wherein a relationship between the at least one incoming instant message and the at least one outgoing instant message is identified.

### BACKGROUND OF THE INVENTION

1. Field of the Invention

The present invention relates generally to an improved data processing system, and more specifically to an improved instant messaging system. Still more specifically, the present invention is a computer implemented method and a computer usable program product for ordering a plurality of instant messages.

2. Description of the Related Art

Instant messaging is an increasingly popular form of instantaneously communicating between two or more individuals using a computer or similar data processing system that is connected to a network. In a conventional instant messaging session, all instant messages are displayed in an instant message window in the order in which the instant messages are received by the instant messaging system. However, in any instant messaging system, delays can cause the instant messages to appear out of logical or “thought” order. Thought order is the order in which a conversation between one or more individuals would take place. The delays can be caused by a number of reasons, including transmission delays or delays by a user in typing an instant message. As a result, difficulty and confusion sometimes arise when one user responds to an instant message, but several other instant messages have been received in the meantime. More difficulties arise when several participants are engaged in a multi-participant session.

Currently, no adequate solution exists that allows for the selection and organization of particular instant messages in an instant messaging system. These solutions exist for an electronic mail system, but no adequate solution related to an instant messaging system currently exists.

### SUMMARY OF THE INVENTION

A computer implemented method and a computer usable program product for ordering a plurality of instant messages are provided. A data processing system receives at least one incoming instant message. Responsive to identifying the at least one incoming instant message as a response to at least one outgoing instant message originating from the data processing system, the data processing system associates the at least one incoming instant message with the at least one outgoing instant message to form a set of related messages. The data processing system presents the at least one incoming instant message to a first user, wherein a relationship between the at least one incoming instant message and the at least one outgoing instant message is identified.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems, in which illustrative embodiments may be implemented;

FIG. 2 is a block diagram of a data processing system, in which illustrative embodiments may be implemented;

FIG. 3 is an instant message ordering system, in accordance with an illustrative embodiment;

FIG. 4 illustrates an instant message timeline in which instant messages are automatically related by timestamp, in accordance with an illustrative embodiment;

FIG. 5 illustrates an exemplary instant message history for a multi-participant session, in accordance with an illustrative embodiment;

FIG. 6 depicts a user preference graphical user interface, in accordance with an illustrative embodiment;

FIG. 7 depicts an instant message session in which the user selects to which instant message to respond, in accordance with an illustrative embodiment;

FIG. 8 is a flowchart illustrating the process for ordering a plurality of instant messages, in accordance with an illustrative embodiment; and

FIG. 9 is a flowchart depicting the process for responding to a plurality of instant messages, in accordance with an illustrative embodiment.

### DETAILED DESCRIPTION OF THE PREFERRED EMBODIMENT

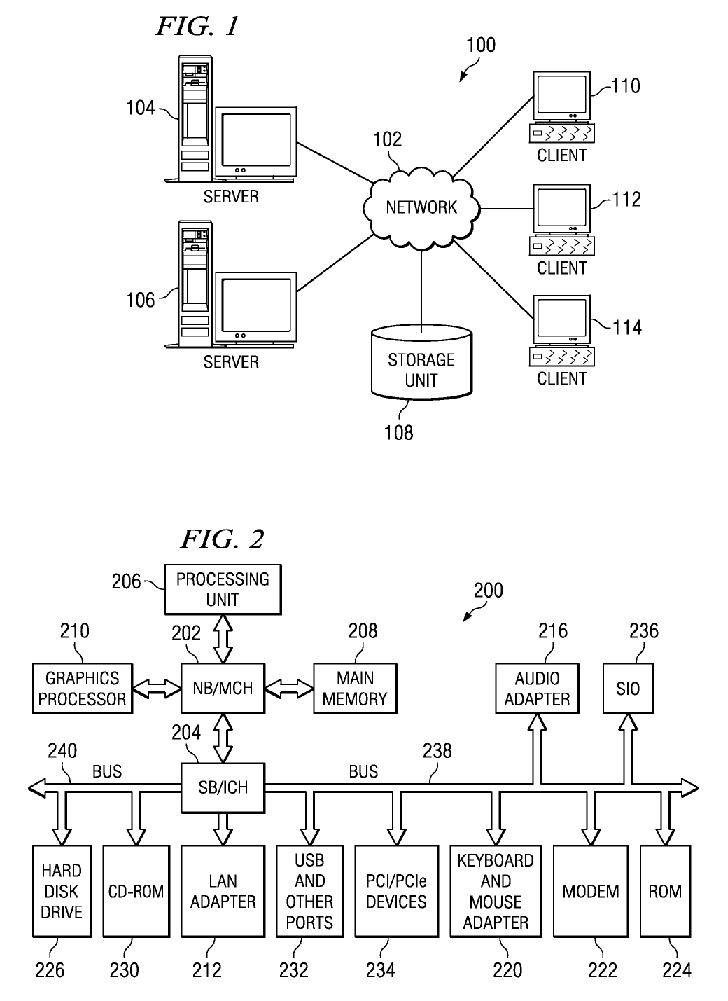

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge (NB) and memory controller hub (MCH) 202 and a south bridge (SB) and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, super I/O (SIO) device 236, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface.

An operating system runs on processor 206 and coordinates and provides control of various components within data processing system 200 in FIG. 2. The operating system may be a commercially available operating system such as Microsoft® Windows® XP or Linux®. Microsoft® and Windows® are registered trademarks of Microsoft Corporation in the United States, other countries, or both. Linux® is a registered trademark of Linus Torvalds in the United States, other countries, or both. An object oriented programming system, such as the Java™ programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object-oriented programming system, applications or programs, and other data are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and the above-described examples are not meant to imply architectural limitations. For example, data processing system 200 also may be a tablet computer, laptop computer, or telephone device in addition to taking the form of a PDA.

The illustrative embodiments provide a computer implemented method and a computer usable program product for automatically ordering a plurality of instant messages. A first data processing system receives at least one incoming instant message. In response to identifying the at least one incoming instant message as a response to at least one outgoing instant message originating from the first data processing system, the first data processing system associates the at least one incoming message with the at least one outgoing instant message using an ordering tag to form a set of related messages. The data processing system indicates the relationship to a first user of the first data processing system.

In the illustrative embodiment, a second data processing system automatically creates an association between instant messages by comparing the timestamps for each instant message. In one embodiment, the timestamp for the at least one incoming instant message is the time when the at least one incoming instant message is received by a second user. In this embodiment, the second user uses the second data processing system to create the response to the at least one incoming instant message. The second data processing system then records the time when the second user types the first character of the response to the at least one incoming instant message. The recorded time forms the timestamp for the reply to the corresponding incoming instant message.

The second data processing system then automatically associates the instant messages using the timestamps. To form the set of related messages, the data processing system for the second user determines which incoming instant message's timestamp is closest to the timestamp of the reply. After identifying the two instant messages, the second data processing system links the two instant messages together to form a set of related messages by updating the ordering tag associated with the incoming instant message and sending the updated tag with the reply. The ordering tag identifies the instant messages to which the particular instant message is related. The ordering tag can include a message string identification (also referred to herein as a message group identification), which identifies the string (also referred to herein as a group) of messages of which the instant message is a part. The ordering tag can also include an ordering identification which identifies the order in which the instant messages in the set of instant messages should be presented to the first user.

Instead of using the time when the second user begins writing the reply, other embodiments might use the time at which the at least one incoming instant message is transmitted by the data processing system of the second user as the timestamp for the reply to the at least one incoming instant message. For example, the time of transmission can be identified when the <Enter> key is pressed or when the <Send> icon is selected by the second user. In this embodiment, the second data processing system still determines which incoming instant message's timestamp is closest to the timestamp of the reply. The second data processing system then links the two instant messages together by updating the ordering tag associated with the incoming instant message and sending the updated tag with the reply.

Upon receipt of the reply, the first data processing system then uses the ordering tag of the reply to present the reply to a first user in such a way that a relationship between the reply and the at least one outgoing instant message sent by the first user is identified. In one embodiment, the reply and the at least one outgoing instant message are presented to the first user by highlighting the related messages using a similar color. In another embodiment, a separate window is initialized that groups the related messages. In yet another embodiment, the data processing system initializes a pop-up window that notifies the first user that the response to the at least one outgoing message is available. The notification can also include a hyperlink or a scroll bar which identifies the reply to the at least one outgoing instant message. In still yet another embodiment, the plurality of instant messages in the data processing system for the first user can be re-ordered such that the response is placed immediately subsequent to the corresponding outgoing instant message. In this embodiment, the response can be slightly indented and/or highlighted to show the relationship.

The illustrative embodiments also provide a computer implemented method for manually responding to one of a plurality of incoming instant messages. The data processing system receives at least one incoming instant message. The user of the data processing system then selects the at least one incoming instant message as an instant message to which the user wishes to form a response. In one embodiment, the user selects the instant message by clicking on the particular instant message. In another embodiment, the user identifies the instant message by highlighting the specific instant message. The data processing system then transmits the outgoing instant message, which is the response to the selected incoming message, along with an updated ordering tag which indicates related instant messages and their respective order. The response message indicates that the instant message is a response to the at least one incoming instant message. The outgoing response message and the at least one incoming instant message then form a set of related messages.

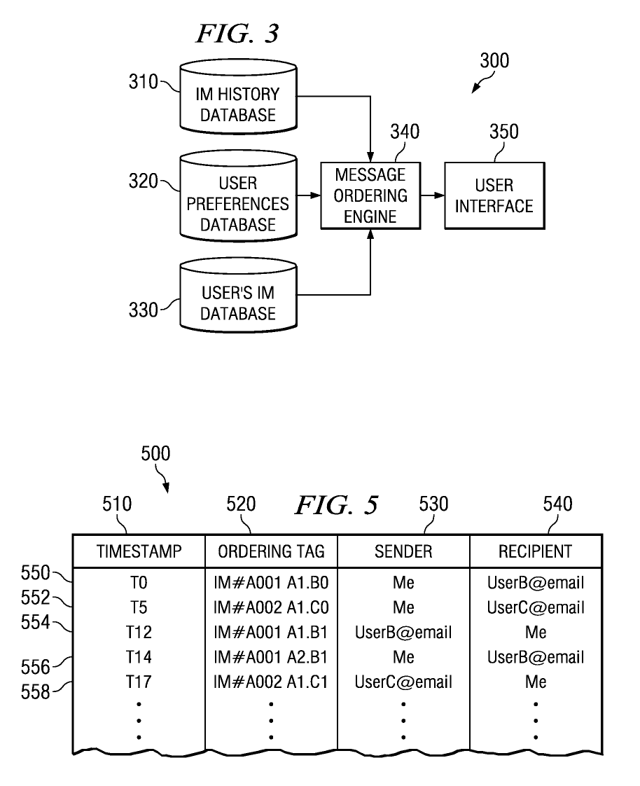

FIG. 3 is an instant message ordering system, in accordance with an illustrative embodiment. Data processing system 300 is a system that organizes and manages incoming and outgoing instant messages. Data processing system 300 can be implemented at a user's client or at a server, such as clients 110, 112 and 114 or servers 104 and 106 of FIG. 1 or data processing system 200 of FIG. 2. Data processing system 300 includes instant message (IM) history database 310, user preferences database 320, user's instant message (IM) database 330, message ordering engine 340, and user interface 350. All components in data processing system 300 are a combination software-based and hardware-based embodiment. However, in alternative embodiments, data processing system 300 can be an entirely software or an entirely hardware embodiment.

IM history database 310 can store a history of all incoming and outgoing instant messages (IMs) for the user of data processing system 300. In the illustrative embodiment, an IM can be in any format, including but not limited to a written IM or a video IM. IM history database 310 can be implemented in the main memory of the data processing system, similar to main memory 208 of FIG. 2, or the hard disk drive of the data processing system, similar to hard drive 226 of FIG. 2. IM history database 310 can store data in any format, including but not limited to a table, a flat file, an Extensible Markup Language (XML) file, a relational database management system, or any combination thereof. In the illustrative embodiment, IM history database 310 stores data as a table.

IM history database 310 can store a variety of information associated with each IM, such as the name of the external sender, the email address for the sender, the internet protocol address for the sender, and the body of the IM. An external sender is a data processing system for a user external to data processing system 300. In the illustrative embodiment, each IM stored in IM history database 310 includes an ordering tag indicating the respective IM's relationship to other IMs in the database.

IM history database 310 permits a user to designate a set of IMs to be saved over a period of time. The IMs are saved until the IM is designated to be deleted. In one embodiment, IM history database 310 automatically deletes the IM after the IM is sent. In another embodiment, IM history database 310 automatically deletes the IM after a pre-determined period of time, such as after one hour or three days. In yet another embodiment, user's IM history database 310 deletes the IM only after the user indicates that the IM is to be deleted.

User preferences database 320 stores the personal preferences for a user of data processing system 300. User preferences database 320 can be implemented in the memory or on the hard disk drive of data processing system 300. A user preference is a computer setting for a particular application. A user preference can be a default setting, set up by an administrator, or a setting established by a user. A user preference can be, for example, the display color, the font, and the size limit of any IMs. In the illustrative embodiment, the user preference indicates the preferred method for organizing and responding to IMs. Specifically, in the illustrative embodiment, a user preference indicates whether incoming and outgoing IMs are to be organized serially or in thought order.

User's IM database 330 stores the IMs the user is in the process of writing and all the IMs sent or received in the current IM sessions. In the illustrative embodiment, if a user wishes to a save a particular set of IMs, the user can designate the set of IMs to be saved in IM history database 310. A set of IMs can be a single IM or a number of incoming and outgoing IMs. Otherwise, all IMs involved in the current IM session are deleted after the user exits the IM session.

User's IM database 330 can be implemented in the main memory or hard disk drive of data processing system 300. In the illustrative embodiment, each IM created or received by the user includes an ordering tag indicating the current IM's relationship to other IMs. User's IM database 330 can store a single IM or a plurality of IMs. In other words, a user can begin a number of incomplete IMs, and the user's IM message database 330 will store all the IMs until the IMs are designated to be sent, saved in IM history database 310, or deleted by the user, or the IM session ends.

Message ordering engine 340 organizes all incoming and outgoing IMs based on the user preferences stored in user preferences database 320 and presents the IMs to the user via user interface 350. Message ordering engine 340 can be executed in a processing unit, similar to processing unit 206 of FIG. 2. In one embodiment, message ordering engine 340 groups together all related IMs. Related IMs comprise a single conversation or thread of IMs. A single thread includes the original message and any response(s) associated with the original message. The response can include only the current IM, or the entire history of responses including the current IM and the original message.

In yet another embodiment, message ordering engine 340 organizes IMs into a logical order or in thought order. Thought order is the order in which a conversation between one or more individuals would take place. Thus, in this embodiment for incoming IMs, message ordering engine 340 inserts the related IMs into the appropriate position in the string (group) of IMs based upon the IM ordering tag which accompanies each IM. An IM ordering tag is an identification attached to each IM which identifies the original creator of the IM as well as the intended recipients for the IM. An IM ordering tag also identifies the order of IMs and is used to identify related IMs.

However, in an alternative embodiment, message ordering engine 340 can also organize IMs according to which incoming message the sender selects to send a response. In this embodiment, message ordering engine 340 identifies the previously received message to which the sender is responding and inserts the incoming message after the previously received message. In this case, the ordering also takes place according to the IM ordering tag which accompanies each IM.

For outgoing messages, in one embodiment, message ordering engine 340 automatically relates an incoming message and its response message based on timestamps for the incoming and response messages. Message ordering engine 340 identifies the time of the incoming IM closest to the time of the response IM. Thus, message ordering engine 340 compares the timestamps for the incoming IMs against the timestamp for the response IM, and the IMs closest in time are grouped together and identified as related messages. Message ordering engine 340 records the identification of related messages in the ordering tag for the response IM.

In another embodiment for outgoing messages, message ordering engine 340 provides a mechanism for the user to manually select to which IM to respond. Depending on implementation, the user can select the IM in a number of ways, including but not limited to double-clicking on the specific IM or right-clicking on the IM. After selecting the IM, message ordering engine 340 can provide a separate window where the user can type the response or split the current instant messaging window to include a separate dialog section.

In yet another embodiment for outgoing messages, message ordering engine 340 provides a user with the capability of communicating with a subset of individuals in a multi-participant session. A multi-participant session is an IM session which includes more than two individuals participating in a conversation. In this embodiment, message ordering engine 340 allows a user to select to which recipients to send an original or response IM. The recipient can be an individual or a group of individuals. The group of individuals can be predetermined by a default setting or by the user, or the group of individuals can be identified during the multi-participant session.

User interface 350 executes instructions for presenting IMs on a display, such as a display screen. User interface 350 is the component by which the user reads any incoming IMs and creates any outgoing IMs. In the illustrative embodiment, message ordering engine 340 presents the organized IMs to the user using user interface 350. For example, all related IMs can be highlighted, identified in a different color, bolded, underlined, or any combination thereof. Additionally, as another example, all related IMs can begin blinking. In still another example, another window or a pop-up window with a hyperlink or scrollbar pointing to all related IMs can be presented. In this embodiment, the window or pop-up window can also include a label, such as “new message”. In yet another example, all the related IMs can be presented in a separate IM window.

The illustrative embodiment is not limited to the illustrative example. For example, data processing system 300 can include more or fewer components. Furthermore, one or more of the presented illustrative embodiments can be combined without deviating from the scope of the invention. Moreover, other instant messaging features, such as converting text IMs to and from audio so that user interface 350 can be a telephone, can be included within data processing system 300 without deviating from the scope of the invention. Furthermore, IM history database 310 and user's IM database 330 can be a single component and may not be separate components.

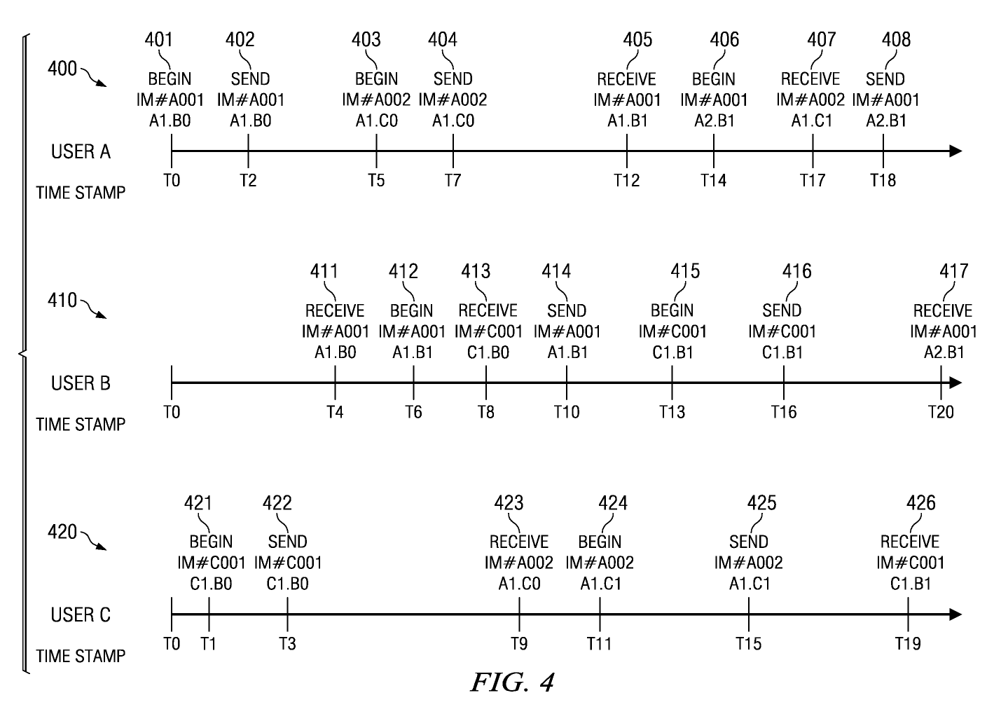

FIG. 4 illustrates an instant message timeline in which instant messages are automatically related by timestamp, in accordance with an illustrative embodiment. In the illustrative embodiment, Users A, B, and C are conducting a multi-participant instant messaging (IM) session. Timeline 400 illustrates the IM activity for User A, while timeline 410 depicts the instant messaging activity for User B. Timeline 420 depicts the IM activity for User C. All timelines 400, 410, and 420 can be created by an IM ordering system, similar to data processing system 300 of FIG. 3, and, it should be understood, the particular timelines provided herein are for illustrative purposes only.

In the illustrative embodiment, the data processing system links related messages to each other using a message ordering tag for IMs which have matching IM numbers. The message ordering tag includes a message string identifier, which identifies a particular string (group) of messages in which the respective IM is a part. Specifically, in the illustrative embodiments, one original message and its related IMs have a message string (group) identifier of “IM#A001”. The “A” in the ordering tag indicates that User A originated the string (group) of related IMs. If another user originates the string (group) of related IMs, the corresponding user's identification will appear in the same location in the ordering tag. Thus, any IMs originated by user B will have message string (group) identifier of “IM#B001”, for user C, “IM#C001”. The “001” in the ordering tag indicates that the current message string (group) is the first message originated by the user in the current IM session. Any subsequent string (group) of related messages will have a different number, such as “IM#A002” or “IM#A010”.

Furthermore, the data processing system orders the IMs which are part of a particular string (group) using an ordering identifier. Specifically, in the illustrative embodiment, the ordering identifier is shown as the “Ax.By” tag associated with each IM. The “Ax” value is associated with all IMs written by User A, and the “By” value is associated with all IMs written by User B in response. User A is identified first in the ordering tag since User A is the initiator of the IM string (group). In other words, User A creates and transmits the first IM in this string (group) of IMs. User B is the recipient of the IMs created by User A. Additional participants can be added to the end of the ordering tag after “By”. For example, if User C is also to be a recipient of a message created by User A, then the ordering tag will have a format of “Ax.By.Cz”. The ordering tag will have a similar format for any additional participants included in the IM session.

In the illustrative embodiment, each IM is ordered according to alternating, increasing “x”, “y”, and “z” values, beginning with the IM in the “x” position. A number zero in the “x”, “y”, or “z” position indicates that no message has been created by User A, User B, or User C, respectively. A number one in the “x”, “y”, or “z” position indicates that the particular message is the first message generated by User A, User B, or User C, respectively, with each increasing number being the next message created by the user. Thus, for example, the ordering tag “A1.1B0” is identified as the original message created by User A. “A1” indicates that the current message is the first message created by User A. The “B0” indicates that user B has not created a message yet. User B responds to the original message with the response having an ordering tag “A1.B1”. User A's response to the message with tag “A1.B1” has the ordering tag “A2.B1”, with User B's response having an ordering tag of “A2.B2” and so forth. So for each individual participant, the ordering of IMs and the modification of the ordering tags for responses occurs in a similar manner as they would if there were only two participants.

If there are multiple participants, some modifications to the updating and ordering algorithms may be desirable. For example, if User A receives responses “A#001 A1.B1.C0” and “A#001 A1.B0.C1” the response from User A to Users B and C should be “A#001 A2.B1.C1” since first responses have been received from both User B and User C. This can result in two IMs having identical ordering tags. In this case, the two IMs with the same ordering tag will be sorted sequentially in the string (group), (i.e. listed together) and within that pairing, should be listed for each user in the order in which they were received or sent by that user.

In the illustrative embodiment, timeline 400 includes activities 401 through 408, timeline 410 includes activities 411 through 417, and timeline 420 includes activities 421 through 426. The IM session begins with User A beginning to write IM#A001 A1.B0 at time T0 (activity 401). In the illustrative embodiment, time T0 is the beginning time and is the time when User A types the first character into “IM#A001 A1.B0”.

In the meantime, as User A is writing IM message “IM#A001 A1.B0”, User C begins writing “IM#C001 C1.B0” to User B at time T1 (activity 421). “IM#A001 A1.B0” is then sent or transmitted to User B at time T2 (activity 402), and “IM#C001 C1.B0” is sent to User B at T3 (activity 422). User B receives “IM#A001 A1.B0” at time T4 (activity 411). At time T5, User A then begins a second message, “IM#A002 A1.C0”, but addressed to User C (activity 403).

While User A is writing “IM#A002 A1.C0”, User B begins writing the response, “IM#A001 A1.B1”, to User A's message “IM#A001 A1.B0” at time T6 (activity 412). To identify User B's response as a related message to User's A's message “IM#A001 A1.B0”, User B's response is associated with the incoming IM with the closest timestamp (T4) to User B's response. In the illustrative embodiment, User B only received one incoming message, “IM#A001 A1.B0”. Thus, “IM#A001 A1.B0” is the IM closest in time to when User B began creating the response at time T6. Alternatively, instead of automatically relating by timestamp, User B can select to respond to “IM#A001 A1.B0” using a user interface, similar to user interface 350 of FIG. 3.

User A then completes and transmits “IM#A002 A1.C0” to User C at T7 (activity 404). As User B is writing responding IM “IM#A001 A1.B1” to User A, User B receives “IM#C001 C1.B1” from User C at time T8 (activity 413). User C then receives “IM#A002 A1.C0” from User A at time T9 (activity 423). User B then transmits “IM#A001 A1.B1” to User A at time T10 (activity 414).

At time T11, User C then begins writing “IM#A002 A1.C1” in response to “IM#A002 A1.C0” (activity 424). “IM#A002 A1.C1” is associated with “IM#A002 A1.C0” as related messages either automatically by timestamp (T9) or by having User C select to respond to “IM#A002 A1.C0”.

At time T12, User A receives “IM#A001 A1.B1” from User B (activity 405). “IM#A001 A1.B1” is associated with “IM#A001 A1.B0” by the ordering tag. Specifically, in the illustrative embodiment, the data processing system for User A reads tag number “IM#A001” and recognizes the response from User B as part of the first set of related messages originating from User A. The data processing system for User A then reads the ordering tag “A1.B1” and recognizes that User B's response is to User A's original message.

At time T13, User B begins writing “IM#C001 C1.B1” in response to User C's original message “IM#C001 C1.B0” (step 415). The data processing system for User B automatically associates User B's message, “IM#C001 C1.B1”, with User C's original message “IM#C001 C1.B0” by comparing the timestamps (T8 and T13) of the two IMs. At time T14, User A begins to respond to User B's response with “IM#A001 A2.B1” (activity 406). The data processing system for User A automatically relates “IM#A001 A2.B1” by timestamp since T12 is the closest timestamp to T14.

At T15, User C transmits “IM#A002 A1.C1” to User A (activity 425), and User B transmits “IM#C001 C1.B1” to User C at T16 (activity 416). At T17, User A receives “IM#A002 A1.C1” from User C (activity 407). User A then transmits “IM#A001 A2.B1” to User B at T18 (activity 408). User C then receives “IM#C001 C1.B1” from User B at T19 (activity 426). User B receives “IM#A001 A2.B1” from User A at T20 (activity 417). Users A, B, and C can continue to write and respond to the different threads of IMs for an infinite period of time, with each subsequent message associated with the previous IM based on timestamps or by the respective user selecting the particular IM to which to respond.

The illustrative embodiment is not limited to the illustrated example. For example, the content of each IM and each subsequent responding IM can include a variety of information. Additionally, times T0 through T20 are not limited to a particular period of time, but can be any period of time ranging from, for example, seconds to days. Furthermore, the illustrative embodiment can include more or fewer participant in the IM session. Moreover, the timestamps for each IM may or may not be transmitted with the IM itself.

FIG. 5 illustrates an exemplary instant message history for a multi-participant session, in accordance with an illustrative embodiment. Table 500 lists the sent and received instant messages (IMs) for a current multi-participant IM session. In the illustrative embodiment, table 500 is a database of IMs for User A. Table 500 can be stored in a user's IM database, similar to user's IM database 330 of FIG. 3. In the illustrative embodiment, table 500 includes timestamp column 510, ordering tag column 520, sender column 530, and recipient column 540.

Timestamp column 510 indicates the time at which the IM is received or is created by User A. The time of creation is the time when the user types the first character for the IM. In an alternative embodiment, timestamp column 510 can indicate the time when a data processing system transmits the specific IM. The time of transmittal can be the time when a user hits the <Enter> key or selects the <Send> icon.

Ordering tag column 520 is the identification tag for the particular IM. The ordering tags listed in ordering tag column 520 are similar to the ordering tags illustrated in FIG. 4. Each ordering tag has a format similar to “IM#A001 A1.B0”. The “A” in “IM#A001” identifies the user that originated the message, specifically, in the illustrative embodiment, User A. The “001” indicates that this IM is the first message written by User A in the current IM session. The “A1.B0” indicates that this IM is written by User A and is intended for User B. All other ordering tags in ordering tag column 520 have a similar format as the illustrated example.

Sender column 530 identifies the user who wrote the specific IM. In the illustrative embodiment, if the particular IM is written by the User A, then sender column 530 depicts the sender as “Me”, such as in rows 550, 552, and 556. If, on the other hand, the IM is written by another user, then sender column 530 indicates the electronic mail (email) address for the sender. In an alternative embodiment, instead of an email address, sender column 530 can display the name, the IP address, the job title, the nickname for the sender, or any other identification for the sender. Similarly, instead of indicating “Me” for IMs written by User A, sender column 530 can display the email address or another form of identification for User A.

Recipient column 540 identifies the intended recipient of the particular IM. Similar to recipient column 540, “Me” indicates that User A is the recipient of a particular IM, and an email address identifies any other user for which the IM is intended.

Rows 550 through 558 illustrate five IMs sent or received by User A in the current IM session. Row 550 illustrates that User A is writing an outgoing IM, “IM#A001 A1.B0” to “UserB@email.com” at timestamp “T0”. Row 552 indicates that User A is writing a second outgoing IM, “IM#A002 A1.C0” to UserC@email.com at timestamp “T5”. Row 554 depicts User A receiving an IM, “IM#A001 A1.B1” from “UserB@email” at “T12”. The IM from User B is a response to User A's original IM transmitted at “T0”. In response to User B's reply, in Row 556, User A begins writing “IM#A001 A2.B1” to “UserB@email.com” at timestamp “T14”. At “T17”, User A receives “IM#A002 A1.C1” from “UserC@email.com”.

The illustrative embodiment is not limited to the illustrated example. For example, more or fewer columns and rows can be included in table 500. Additionally, table 500 is not limited to only a single IM session, but can be used to record the history for a number of IM sessions. Furthermore, timestamp column 510 can reflect time in any other format, including, but not limited to a 12-hour or 24-hour format.

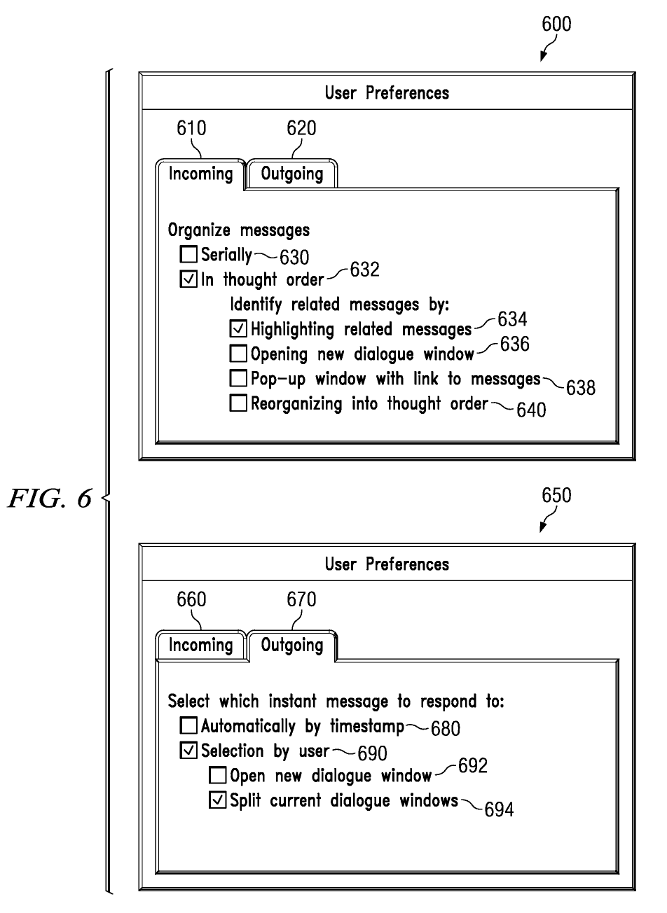

FIG. 6 depicts a user preference graphical user interface, in accordance with an illustrative embodiment. User preferences windows 600 and 650 are graphical user interfaces (GUIs) for selecting the preferred method of organizing and responding to incoming IMs. User preferences 600 and 650 can be stored in a user preference database, such as user preference database 320 of FIG. 3, and presented on a user interface, such as user interface 350 of FIG. 3.

User preference window 600 includes incoming tab 610 and outgoing tab 620, with incoming tab 610 being selected in the illustrative embodiment. In incoming tab 610, a user can choose how to organize any incoming IMs. In the illustrative embodiment, incoming messages can be organized serially (line 630) or in thought order (line 632). If incoming messages are organized serially (line 630), then all incoming messages are organized one after another as each IM is received by the data processing system. Therefore, the incoming IMs are not grouped together but are presented sequentially. On the other hand, if incoming messages are organized in thought order (line 632), then all incoming messages are grouped together in a logical order or in an order in which a conversation takes place. Related IMs can be identified in four ways: (1) by highlighting the related messages (line 634); (2) by opening a new dialogue window (line 636); (3) by opening a pop-up window with a link to the related messages (line 638); or (4) by reorganizing the IMs into thought order (line 640). If reorganized into thought order, the incoming IMs are inserted into the appropriate location in the string (group) of IMs. The incoming messages can be inserted using the IM ordering tag which accompanies each IM. In the illustrative embodiment, all incoming messages are to be organized by related IMs, with all related IMs highlighted.

In the illustrative embodiment, the selection of which method of identifying related IMs is exclusive and implemented using a radio button interface. A radio button interface is a type of graphical user interface widget that allows a user to choose a particular option from a set of alternatives. Typically, once an option is selected, the remaining unselected options become deselected. However, in alternative embodiments, more than one method of identifying related IMs can also be selected.

User preference window 650 is similar to user preference window 600, except that outgoing tab 670 is selected instead of incoming tab 660 for user preference window 650. In outgoing tab 670, the methods of selecting which IM to respond to can be done automatically by timestamp (line 680) or selected by the user (line 690). If responses are tied to incoming messages by timestamp (line 680), then the timestamp of the incoming message is compared against the timestamp of the response or outgoing message. The timestamp of the incoming message is determined by the time at which the message was received.

In the illustrative embodiment, if the data processing system automatically identifies the IM by timestamp, then the data processing system can identify the related IM when the user begins typing the IM. The related IM can be identified by highlighting, bolding, a different color font, a different sized font, or any combination thereof. Alternatively, the data processing system can also begin blinking the related IM.

Furthermore, in an alternative embodiment, the data processing system can provide a means for allowing the user to override the IM that is automatically selected. In other words, if the data processing system identifies the wrong IM or the user begins responding after several IMs have been received, then the user can identify another IM to respond to after the data processing system automatically selects a particular IM. In this embodiment, the data processing system can provide the option by including the option as a user preference in user preference window 650. Alternatively, the user can override by right-clicking in the IM to which the user is writing the response. In yet another alternative, the data processing system can provide a separate pop-up window that provides the option to override the automatically selected IM.

If the determination of which IM to respond to is selected by the user (line 690), then the user can identify how to respond to the selected IM. Either a new dialogue window (line 692) can be opened or the current dialogue window can be split (line 694) to include a dialogue for the selected IM. In the illustrative embodiment, the user will select to which IM to respond, and the current dialogue window will be split to allow the user to respond to the selected IM.

Additionally, if the “selected by user” preference is selected, the data processing system can provide additional instructions on how to select the appropriate IM to which to respond. For example, the data processing system can provide a pop-up window instructing the user to right-click or highlight the particular IM in which the user wishes to respond.

The illustrative embodiment is not limited to the illustrated example. For example, user preference windows 600 and 650 can include more or fewer tabs. Additionally, incoming tabs 610 and 660 and outgoing tabs 620 and 670 can also include more or fewer choices. Furthermore, the format, organization, and aesthetic presentation of user preference window 600 and 650 can be modified without deviating from the scope of the illustrative embodiments.

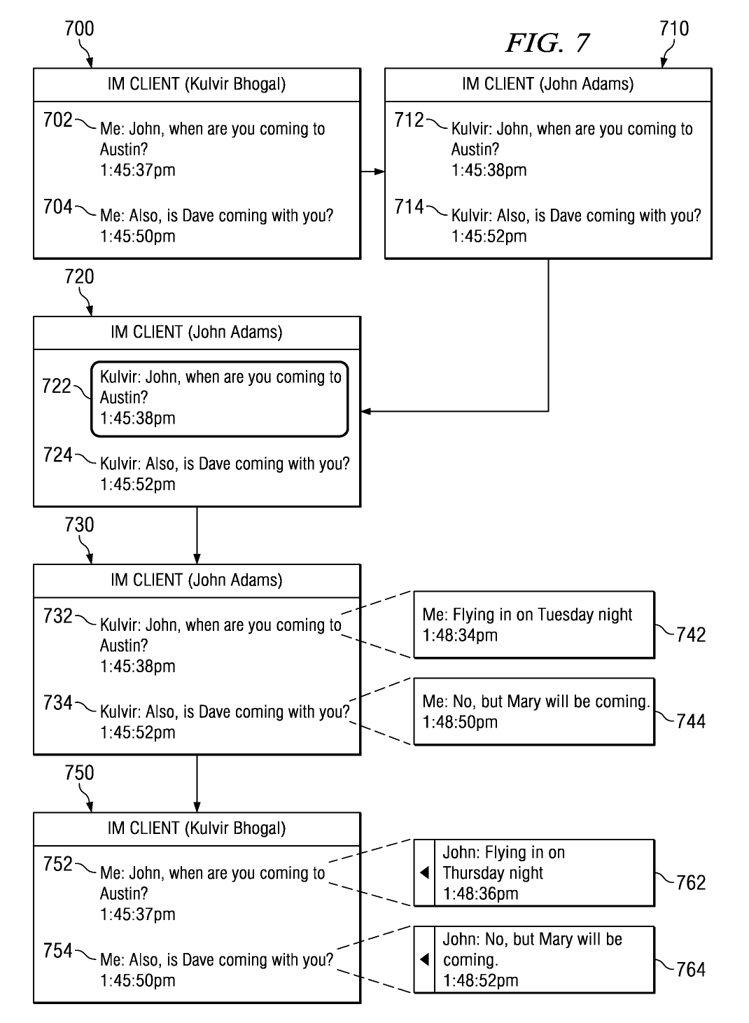

FIG. 7 depicts an instant message session in which the user selects to which instant message to respond, in accordance with an illustrative embodiment. The IM session in FIG. 7 can be implemented in a data processing system similar to data processing system 300 of FIG. 3.

In the illustrative embodiment, instant message (IM) windows 700, 710, 720, 730 and 750 depict the progression of an IM session between two participants. IM windows 700 and 750 illustrate the IM GUI for the IM client of “Kulvir Bhogal”, while IM windows 710, 720 and 730 depict the IM GUI for the IM client of “John Adams”. In the illustrative embodiment, all the timestamps indicate the times at which the IMs were received or created, with the times based on a 12-hour format.

In the illustrative embodiment, “Kulvir Bhogal” begins an IM session with IMs 702 and 704 in IM window 700, with each typed message created by “Kulvir Bhogal” identified as “Me”. IM 702 is created at 1:45:37 PM asking “John, when are you coming to Austin?” IM 704 is a second, subsequent IM sent by “Kulvir Bhogal” and is created at 1:45:50 PM asking “Also, is Dave coming with you?“

IM window 710 shows that “John Adams” receives IMs 712 and 714 from “Kulvir”. IM 712 has a time-received timestamp of 1:45:38 PM and the same content as IM 702. Likewise, IM 714 has a time-received timestamp of 1:45:52 PM and the same content as IM 704.

IM window 720 includes incoming IMs 722 and 724, which include the same content and timestamp as incoming IMs 712 and 714, respectively. In the illustrative embodiment, incoming IM 722 is highlighted, thereby indicating that “John Adams” selected to respond to IM 722.

In the illustrative embodiment, a new window for each response is opened after the particular message is selected by “John Adams”. In IM window 730, “John Adams” created IM 742 in response to incoming IM 732, and IM 744 in response to incoming IM 734. In the illustrative embodiment, IM 742 states “Flying in on Tuesday night” and has a timestamp of 1:48:34 PM. The timestamp in IM 742 indicates the time when “John Adams” typed the first character into IM 742. IM 744 states “No, but Mary will be coming” and includes a timestamp of 1:48:50 PM, which reflects the time when “John Adams” typed the first character into IM 744.

After “John Adams” sends IMs 742 and 744, “Kulvir Bhogal” receives responses 762 and 764 as illustrated in IM window 750. In the illustrative embodiment, IM window 750 presents the responses in a separate window to the right of the related IM. Thus, response 762 is presented to the right of original IM 752, while response 764 is presented to the right of original IM 754. In the illustrative embodiment, responses 762 and 764 automatically display once IM window 750 receives responses 762 and 764. However, in another embodiment, responses 762 and 764 can display only after “Kulvir Bhogal” selects the particular IM 752 or 754. “Kulvir Bhogal” can select IM 752 or 754 in a number of ways, including but not limited to clicking on the message or passing a mouse pointer over the message.

Additionally, in this embodiment, IM window 750 can include an indicator to show that a response to IM 752 or IM 754 has been received. The indicator can be in any form, including but not limited to having related IMs begin to blink, being highlighted, being presented in a different color, being underlined, or any combination thereof. In another embodiment, another window or a pop-up window with a hyperlink or scrollbar pointing to all related IMs can be presented. In this embodiment, the window or pop-up window can also include a label, such as “new message”.

Also, additional threads of the same IM can be displayed. For example, IM 752 can have a number of responses similar to response 762, with each response presented to the right of IM 752. The number of responses can be individually presented, individually cascaded on top of each other, or all within response 762.

In the illustrative embodiment, the timestamp for IM 752 is 1:45:37 PM, which reflects the time when “Kulvir Bhogal” began writing IM 752. Similarly, the timestamp for IM 764 is 1:48:52 PM, which reflects the time when “Kulvir Bhogal” received IM 764.

The illustrative embodiment is not limited to the illustrated example. For example, each IM window 700, 710, 720, 730 and 750 can include more or fewer features and IMs. Additionally, the presentation, organization, and format of these IM windows can change without deviating from the scope of the illustrative embodiments. Furthermore, the IM session in FIG. 7 can be a multi-participant session. Moreover, the timestamps for IM windows 700 through 764 can reflect the time the corresponding IM is transmitted versus the time when either the IM is created or received. Furthermore, each participant in the current IM session can set their respective timestamps to different points in time. In other words, one participant can have a timestamp reflecting the time when all outgoing IMs are created, while another participant can have a timestamp reflecting the time when all outgoing IMs are transmitted. After the related IMs are determined, the ordering information is included in the IM ordering tags of the related IMs.

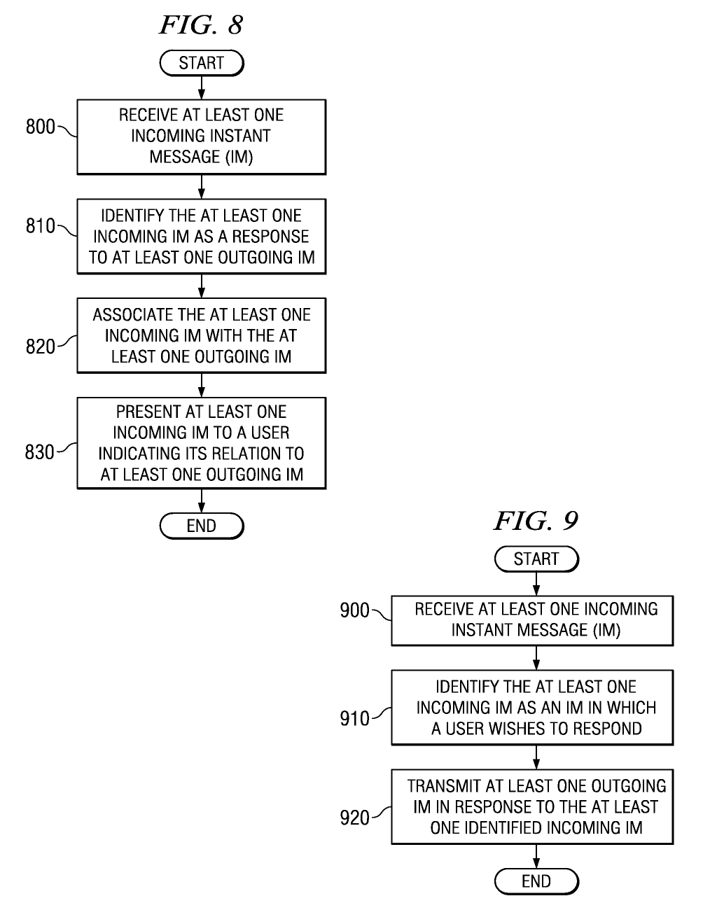

FIG. 8 is a flowchart illustrating the process for ordering a plurality of IMs, in accordance with an illustrative embodiment. The process can be executed in a message ordering engine, similar to message ordering engine 340 of FIG. 3. The following process is exemplary only and the order of the steps may be interchanged without deviating from the scope of illustrative embodiments.

The process begins with the message ordering engine receiving at least one incoming instant message (IM) (step 800). The message ordering engine then identifies the at least one incoming IM as a response to at least one outgoing IM (step 810). The message ordering engine then associates the at least one incoming IM with the at least one outgoing IM (step 820). The message ordering engine then presents the at least one incoming IM to the user, indicating its relationship to the at least one outgoing IM (step 830). The response can be presented by highlighting the related IMs, initializing another IM window that presents the response and the related IM, or initializing a pop-up window that notifies a user that the response to the IM is available. The response can also be presented by reordering the IMs so that the response is immediately subsequent to the related IM. The process terminates thereafter.

FIG. 9 is a flowchart depicting the process for responding to a plurality of IMs, in accordance with an illustrative embodiment. The process can be executed in a message ordering engine, similar to message ordering engine 340 of FIG. 3. The following process is exemplary only and the order of the steps may be interchanged without deviating from the scope of illustrative embodiments.

The process begins with the message ordering engine receiving at least one incoming instant message (IM) (step 900). The message ordering engine then identifies the at least one incoming IM as an IM to which a user wishes to respond (step 910). In one embodiment, the message ordering engine automatically identifies the at least one incoming IM by comparing the received and reply timestamps. In another embodiment, a user selects the at least one incoming IM as the IM to which the user wishes to respond. The message ordering engine then transmits at least one outgoing IM in response to the at least one identified incoming IM (step 920), with the process terminating thereafter.

Thus, the illustrative embodiments provide a computer implemented method and a computer usable program product for automatically ordering a plurality of instant messages. A first data processing system receives at least one incoming instant message. In response to identifying the at least one incoming instant message as a response to at least one outgoing instant message originating from the first data processing system, the first data processing system associates the at least one incoming message with the at least one outgoing instant message using an ordering tag to form a set of related messages. The data processing system indicates the relationship to a first user of the first data processing system.

In the illustrative embodiment, a second data processing system automatically creates an association between instant messages by comparing the timestamps for each instant message. In one embodiment, the timestamp for the at least one incoming instant message is the time when the at least one incoming instant message is received by a second user. In this embodiment, the second user uses the second data processing system to create the response to the at least one incoming instant message. The second data processing system then records the time when the second user types the first character of the response to the at least one incoming instant message. The recorded time forms the timestamp for the reply to the corresponding incoming instant message.

The second data processing system then automatically associates the instant messages using the timestamps. To form the set of related messages, the data processing system for the second user determines which incoming instant message's timestamp is closest to the timestamp of the reply. After identifying the two instant messages, the second data processing system links the two instant messages together to form a set of related messages by updating the ordering tag associated with the incoming instant message and sending the updated tag with the reply. The ordering tag identifies the instant messages to which the particular instant message is related. The ordering tag can include a message string (group) identification, which identifies the string (group) of messages to which the instant message is part. The ordering tag can also include an ordering identification which identifies the order in which the instant messages in the set of instant messages should be presented to the first user.

Instead of using the time when the second user begins writing the reply, other embodiments might use the time at which the at least one outgoing instant message is transmitted by the data processing system of the second user as the timestamp for the reply to the at least one incoming instant message. For example, the time of transmission can be identified when the <Enter> key is pressed or the <Send> icon is selected by the second user. In this embodiment, the second data processing system still determines which incoming instant message's timestamp is closest to the timestamp of the reply. The second data processing system then links the two instant messages together by updating the ordering tag associated with the incoming instant message and sending the updated tag with the reply.

Upon receipt of the reply, the first data processing system then uses the ordering tag of the reply to present the reply to a first user in such a way that a relationship between the reply and the at least one outgoing instant message sent by the first user is identified. In one embodiment, the reply and the at least one outgoing instant message are presented to the first user by highlighting the related messages using a similar color. In another embodiment, a separate window is initialized that groups the related messages. In yet another embodiment, the data processing system initializes a pop-up window that notifies the first user that the response to the at least one outgoing message is available. The notification can also include a hyperlink or a scroll bar which identifies the reply to the at least one outgoing instant message. In still yet another embodiment, the plurality of instant messages in the data processing system for the first user can be re-ordered such that the response is placed immediately subsequent to the corresponding outgoing instant message. In this embodiment, the response can be slightly indented and/or highlighted to show the relationship.

The illustrative embodiments also provide a computer implemented method for manually responding to one of a plurality of incoming instant messages. The data processing system receives at least one incoming instant message. The user of the data processing system then selects the at least one incoming instant message as an instant message to which the user wishes to form a response. In one embodiment, the user selects the instant message by clicking on the particular instant message. In another embodiment, the user identifies the instant message by highlighting the specific instant message. The data processing system then transmits the outgoing instant message, which is the response to the selected incoming message, along with an ordering tag which indicates related instant messages and the respective order. The response message indicates that the instant message is a response to the at least one incoming instant message. The outgoing response message and the at least one incoming instant message then form a set of related messages.

The illustrative embodiments provide a computer implemented method and computer usable program code for organizing and responding to incoming and outgoing instant messages. The illustrative embodiments allow for a user to select to which instant message to respond. Additionally, the illustrative embodiment also organizes responses in conversation or thought order rather than a time-received order.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. Examples of a propagation medium include digital and analog communications links, wired or wireless communications links using transmission forms such as, for example, radio frequency and light wave transmissions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Telephone modems, DSL or cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for ordering a plurality of incoming instant messages, the computer implemented method comprising:
receiving, by a data processing system, at least one incoming instant message;
responsive to identifying the at least one incoming instant message as a response to at least one outgoing instant message originating from the data processing system, associating the at least one incoming instant message with the at least one outgoing instant message to form a set of related messages; and
presenting the at least one incoming instant message to a first user, wherein a relationship between the at least one incoming instant message and the at least one outgoing instant message is identified.

2. The computer implemented method of claim 1, wherein the step of presenting the at least one incoming instant message to a user comprises highlighting the set of related messages.

3. The computer implemented method of claim 1, wherein the step of presenting the at least one incoming instant message to a user comprises initializing a separate window that groups the related messages.

4. The computer implemented method of claim 1 wherein the step of presenting the at least one incoming instant message to a user comprises initializing a pop-up window that notifies the user that the response to the at least one outgoing instant message is available.

5. The computer implemented method of claim 4, wherein the pop-up window comprises one of a scroll up bar or a hyperlink identifying the at least one incoming instant message.

6. The computer implemented method of claim 1, wherein the step of associating the at least one incoming instant message with the at least one outgoing instant message to form a set of related messages comprises:
reading a first ordering tag for the at least one incoming instant message and a second ordering tag for the at least one outgoing instant message;
determining whether the first ordering tag matches the second ordering tag; and
responsive to the first ordering tag matching the second ordering tag, linking the at least one incoming instant message and the at least one outgoing instant message.

7. The computer implemented method of claim 6, wherein the first ordering tag and the second ordering tag comprise a message string identification which identifies the at least one incoming instant message and the at least one outgoing instant message as part of a message string.

8. The computer implemented method of claim 6, wherein the first ordering tag and the second ordering tag comprise an ordering identification which determines the order of the at least one incoming instant message and the at least one outgoing instant message within the message string.

9. A computer implemented method for responding to a plurality of incoming instant messages, the method comprising:
receiving, by a data processing system, at least one incoming instant message;
identifying the at least one incoming instant message as an instant message in the plurality of incoming instant messages to which a user wishes to form a response; and
transmitting an at least one outgoing instant message, wherein the at least one outgoing instant message indicates that the at least one outgoing instant message is a response to the at least one incoming instant message, and wherein the at least one outgoing instant message and the at least one incoming instant message form a set of related messages.

10. The computer implemented method of claim 9, wherein the user wishes to form a response by selecting the instant message to which to form the response.

11. The computer implemented method of claim 9, wherein the user selects the instant message to which to form the response by at least one of clicking on the instant message and highlighting the instant message.

12. The computer implemented method of claim 9, wherein the step of identifying the at least one incoming instant message as an instant message in a plurality of incoming instant messages in which a user wishes to form a response comprises:
identifying an outgoing timestamp for the at least one outgoing instant message;
identifying a closest timestamp to the outgoing timestamp, wherein the closest timestamp is an incoming instant message with the closest time to the at least one outgoing instant message; and
responsive to identifying the incoming instant message with the closest time to the at least one outgoing instant message, associating the incoming instant message with the at least one outgoing instant message.

13. The computer implemented method of claim 12, wherein the closest timestamp is a time when the incoming instant message is received by the data processing system.

14. The computer implemented method of claim 12, wherein the outgoing timestamp is a time when a user types the first character for the at least one outgoing instant message.

15. A computer program product comprising a computer usable medium including computer usable program code for ordering a plurality of instant messages comprising:
computer usable program code for receiving, by a data processing system, at least one incoming instant message;
responsive to identifying the at least one incoming instant message as a response to at least one outgoing instant message originating from the data processing system, computer usable program code for associating the at least one incoming instant message with the at least one outgoing instant message to form a set of related messages; and
computer usable program code for presenting the at least one incoming instant message to a first user, wherein a relationship between the at least one incoming instant message and the at least one outgoing instant message is identified.

16. The computer program product of claim 15, wherein the step of presenting the at least one incoming instant message to a user comprises computer usable program code for at least one of highlighting the set of related messages, initializing a separate window that groups the related messages, and initializing a pop-up window that notifies the user that the response to the at least one outgoing instant message is available.

17. The computer program product of claim 16, wherein the pop-up window comprises one of a scroll up bar or a hyperlink identifying the at least one incoming instant message.

18. The computer program product of claim 16, wherein the computer usable program code for associating the at least one incoming instant message with the at least one outgoing instant message to form a set of related messages comprises:
computer usable program code for reading a first ordering tag for the at least one incoming instant message and a second ordering tag for the at least one outgoing instant message;
computer usable program code for determining whether the first ordering tag matches the second ordering tag; and
responsive to the first ordering tag matching the second ordering tag, computer usable program code for linking the at least one incoming instant message and the at least one outgoing instant message.

19. The computer program product of claim 18, wherein the first ordering tag and the second ordering tag comprises a message string identification which identifies the at least one incoming instant message and the at least one outgoing instant message as part of a message string.

20. The computer program product of claim 18, wherein the first ordering tag and the second ordering tag comprises an ordering identification which determines the order of the at least one incoming instant message and the at least one outgoing instant message within the message string.
